(19) United States
(12) Patent Application Publication
(10) Pub. No.: US 2005/0165774 A1
(43) Pub. Date: Jul. 28, 2005

(54) Method for generating pictorial representations of relevant information based on community relevance determination

(76) Inventors: James J. Andrus, Bow, NH (US); Joseph Puffer, Goffstown, NH (US)

Correspondence Address: Devine, Millimet & Branch, P.A., 111 Amherst Street, Manchester, NH, 03101, US

(21) Appl. No.: 11/089,253

(22) Filed: Mar. 23, 2005

Related U.S. Application Data
(63) Continuation-in-part of application No. 10/180,422, filed on Jun. 26, 2002.
(60) Provisional application No. 60/301,071, filed on Jun. 26, 2001.

(51) Int. Cl. G06F 7/00

(52) U.S. Cl. 707/3

(57) ABSTRACT

A method for generating pictorial representations of relevant information based on community relevance determination. The method includes searching information based on a criteria; reporting resulting information as community items; tracking response of community to the items; calculating relevancy of each item in the community; and generating a graphical representation of relevancy of each item based on community behavior with said item. Also, a method of generating pictorial representations of relevant information based on community relevance determination. The method includes the following steps: searching digital information based on a criteria; copying one copy of resulting information to a community server as community items; tracking response of community machines to the items; determining relevancy of each item in the community using swarm intelligence; assigning a swarm index to the each item; and generating a graphical representation of relevancy of the each item based on community behavior with said item.

The present application is a continuation in part of patent application Ser. No. 10/180,422, filed Jun. 26, 2002 which claims the benefit of Provisional Application Ser. No. 60/301,071, which was filed Jun. 26, 2001, both which are fully incorporated herein by reference.

### TECHNICAL FIELD

The present invention relates to a method for generating pictorial representations of relevant information based on community relevance determination.

### BACKGROUND INFORMATION

Information, including news, is published and available through many electronic sources including the World Wide Web (“Web”). Collecting information by searching these sources using search criteria is easy. However, sorting the information based on relevancy is increasingly difficult due to the volume of results of any given search for information based on any given criteria.

Tracking news relevant to any given criteria is commonly desired. Thus, the volume of news stories returned daily builds quickly into an unwieldy and meaningless database of information. Users tracking news desire efficient reporting of news that is relevant to their needs. Thus, interpretation of the news is a necessary factor.

Organizations often track news related to their organization, competitors or industry in general. Within any given organization the circulation of news is important for the building of competitive intelligence or a situational awareness of a competitive environment.

News aggregation services are available for the common collecting of news, yet these services are limited. A news aggregator is generally a service that combines many publishers into one database where data is displayed by date and/or search. However, news aggregators do not include relevancy calculations or interpretation as integral parts of their news services.

Using search engines to gather information produces problems. Given the number of search engines available to search the Web, efficiency is problematic. Once searches are completed using a number of search engines, the user is left with literally thousands results that match the search criteria (based on each search engines search method). The results are then manually interpreted to determine whether the results are relevant. Because each result needs to be reviewed, this is a very inefficient method of tracking news.

Therefore, a method of tracking news based on given search criteria and determining the relevancy of the results based on a community of users is needed in the art.

### SUMMARY

In accordance with one aspect of the present invention, a method is provided for generating pictorial representations of relevant information based on community relevancy. The method includes searching information based on a criteria; reporting resulting information as community items; tracking response of community to the items; calculating relevancy of each item in the community; and generating a graphical representation of relevancy of each item based on community behavior with the item.

Some embodiments of this aspect of the present invention include one or more of the following. The method can further include the step of updating relevance and graphical representation in real time based on continued community behavior. Additionally, the step of calculating relevancy of each item step can include assigning a swarm index to each item. The step of reporting resulting information can additionally include indicating the most relevant information based on the community behavior. The step of reporting resulting information can further include indicating most relevant information based on each member of said community interaction with said items. The method can include where the information is in digital form. The step of reporting resulting information can further include making one copy of the resulting information on a community-accessed server. The step of generating a graphical representation can include where the graphical representation is event radar. Finally, the step of generating a graphical representation can include where the graphical representation is an interactive display integrated to a news collection and a relevancy creation system.

In accordance with another aspect of the present invention, a method of generating pictorial representations of relevant information based on community relevance determination. The method includes the following steps: searching digital information based on a criteria; copying one copy of resulting information to a community server as community items; tracking response of community machines to the items; determining relevancy of each item in the community using swarm intelligence; assigning a swarm index to the each item; and generating a graphical representation of relevancy of the each item based on criteria and community behavior with the item.

Some embodiments of this aspect of the present invention include one or more of the following. The method can further include the step of updating the swarm index of the items in response to the response of community machines to the items. The method can also include the step of updating relevance and graphical representation in real time based on continued community interaction with the items.

In accordance with another aspect of the present invention, a method for generating pictorial representations of relevant information based on calculated community relevancy. The method includes the steps of: searching information based on a criteria; generating a graphical representation of relevancy; reporting resulting information as community items; tracking response of community to the items; and determining relevancy of each of the items in the community wherein updates based on community relevancy are reflected by adjustments to the generated graphical representation of relevancy.

These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

FIG. 1 is a flow chart showing the overview of the preferred embodiment of the present invention;

FIG. 2 is a flow chart of the process for calculating the Swarm Index according to one embodiment, this calculation being part of the method of the present invention;

FIG. 3 is pictorial view of a screen shot of an Event Radar at time X; and

FIG. 4 is a pictorial view of a screen shot of an Event Radar at time X.

### DETAILED DESCRIPTION OF THE PREFERRED EMBODIMENTS

The invention is a method for generating pictorial representations of relevant information including searching information based on a criteria; reporting resulting information as community items; tracking response of community to said items; determining relevancy of each item in said community; and generating a graphical representation of relevancy of each item based on criteria and community interest.

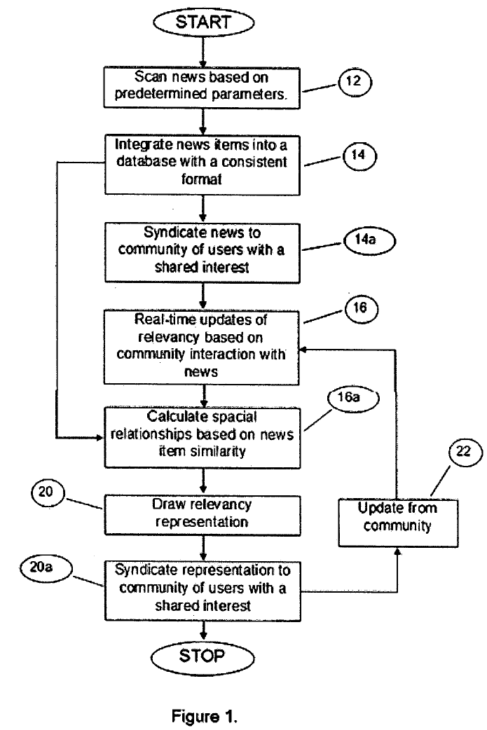

Referring first to FIG. 1, an overview of the method according to one embodiment of the invention is shown. The first step 12 is scanning information/news based on predetermined parameters or criteria. News is used throughout this specification as a broad term to mean any information available. The next step 14 is integrating one copy of each piece of news that meets the criteria into a database with a consistent format.

The step of searching information based on predetermined parameters or criteria 12 can be completed by a news integration platform (“INN”). The INN, in addition to searching news based on predetermined parameters: 1) automatically scans the Internet for public sources of news including: blogs, message boards, and competitor press releases; 2) automatically scans paid subscription services; 3) searches for archived news; 4) organizes news into useful folders; 5) syndicates and shares news with other analysts and editors; 6) allows for editor excerpting and commenting; and 7) creates email news briefings. Thus, the INN searches, integrates and syndicates news. The INN scans these sources based on criteria or predetermined parameter. The criteria can be any search term(s) desired. The INN can scan virtually any source available, either publicly or privately.

The next step in the method is integrating the news or criteria 14. As discussed above, the INN integrates the news and organized the news into useful folders. However, in other embodiments, the integration is simply listing and not organizing into folders.

The next step 14a is syndicating the news in a database with one or many users in a community of common interest. There are many methods of news syndication including World Wide Web browser login and email. Recipients of this syndicated news read, comment upon, flag or any number of natural user responses to the news items. These user behaviors are recorded by the news database and serve as inputs to relevancy calculations.

The next step 16 is calculating the real-time relevancy based on user behavior in interacting with syndicated news items. Calculated relevancy can consider any number of user behaviors, the source of the news items, and the status of the users within their communities. Relevant news items are those few, amongst hundreds or thousands of others that users find worthy of human interaction. The relevant news items are then scored to reflect the level of community interaction. This score is a relevancy score. Based on relevancy scores, further syndication of news items within a community can be accomplished where the news items with the higher relevancy scores receive the broadest or targeted syndication.

In the preferred embodiment of the invention, the INN is available to a community via an application service provider (ASP) either by directly accessing INN servers via the Internet, or accessing private versions of INN behind the communities firewall in the community server. The news items are thus available on the server and integrated into a community and available via a server to any number of community machines. One copy of each news item is maintained on the community server. The community server is any server available to the community machines.

As part of the INN information architecture, INN creates and recognizes unique one-to-one relationships amongst all permutations of machines in the community, sources and news articles. For example, the INN network recognizes that a machine accesses a particular news item. It recognizes that a machine has emailed a particular article/news item to another specific machine. It recognizes that an article has been interacted with or commented on by a particular machine. All of these and other interactions amongst connected machines in the community, articles and sources are recognized and captured by the INN database. As described above, each news item can be available to the entire community. As a community machine accesses the item, the relevancy score of that item is affected. Criteria that effects the relevancy score includes accessing the item, emailing the item to another community machine or commenting on the item. These are not the only criteria as any criteria can be programmed into the method for computing the relevancy score.

Responding to the behavior or individual community machines is termed swarm intelligence. Characteristics of swarm intelligence include no centralized control, effective emergent behavior based on unique individual community machines reacting to simple rules and the community server being an effective collector and disseminator of community machine signals.

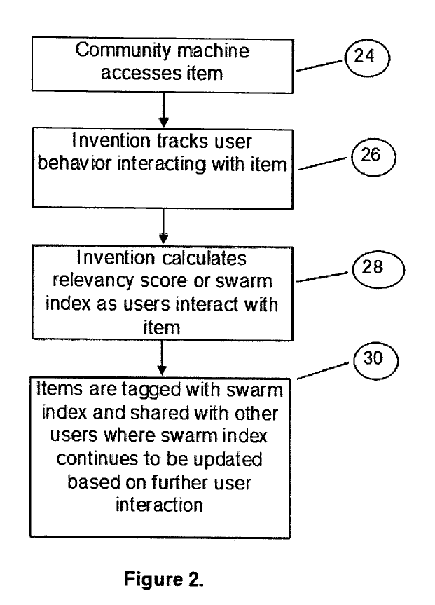

Using swarm intelligence, the relevancy score of the more important news items is increased. This is called the Swarm Index (“SI”) and is the numerical process of tagging more relevant news items. Once more relevant items are highlighted; community machines within an INN network community have access to a listing of relevant items. The relevancy, or SI is calculated per item, in real time, in response to community machine interaction with each of the items. Referring now to FIG. 2, the process for computing the SI according to one embodiment is shown. In step 24, the community machine accesses an item. Next, in step 26, the INN tracks the interaction of that community machine with the item. This step tracks how the community machine interacts with the item using criteria, which include whether the machine forwards the item to another community machine, or whether the machine adds comments to the item. Using these criteria, in step 28, the INN calculates an updated relevance score or SI. Finally, in step 30, the INN assigns an SI to the item and tags the item with the SI. These steps are repeated each time the item is acted on by any community machine.

### Event Radars

Referring back to FIG. 1, step 16a calculates relationships amongst news items based on the words they contain and their calculated relevancy. This calculation is based on algorithms seeking similarities. Once similarities are calculated, further algorithms plot groups of news items amongst each other in a fixed X-Y plot, where similar groups of news items are located near each other. In these algorithms, no groups of news items can occupy the same location on the plot.

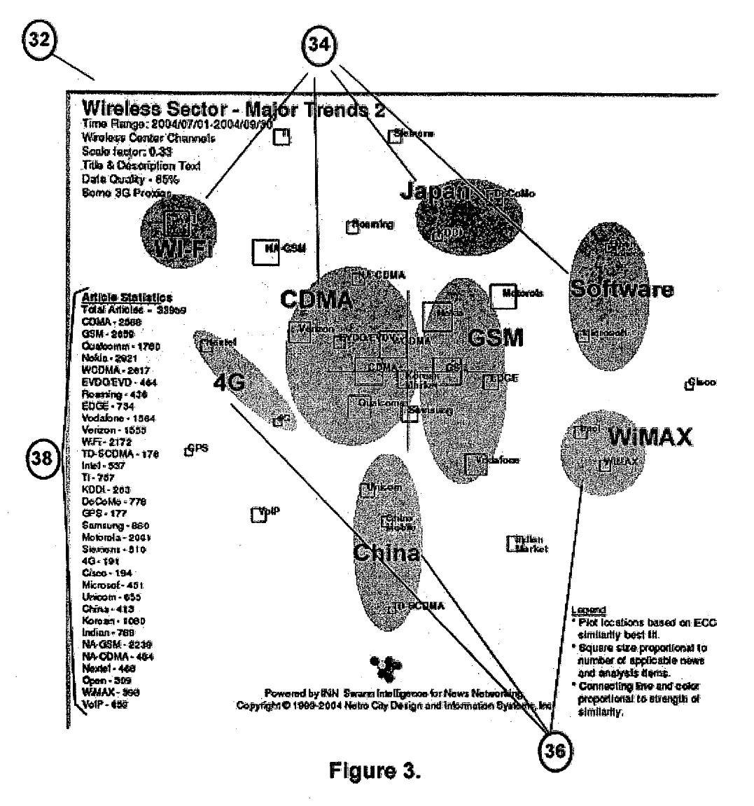

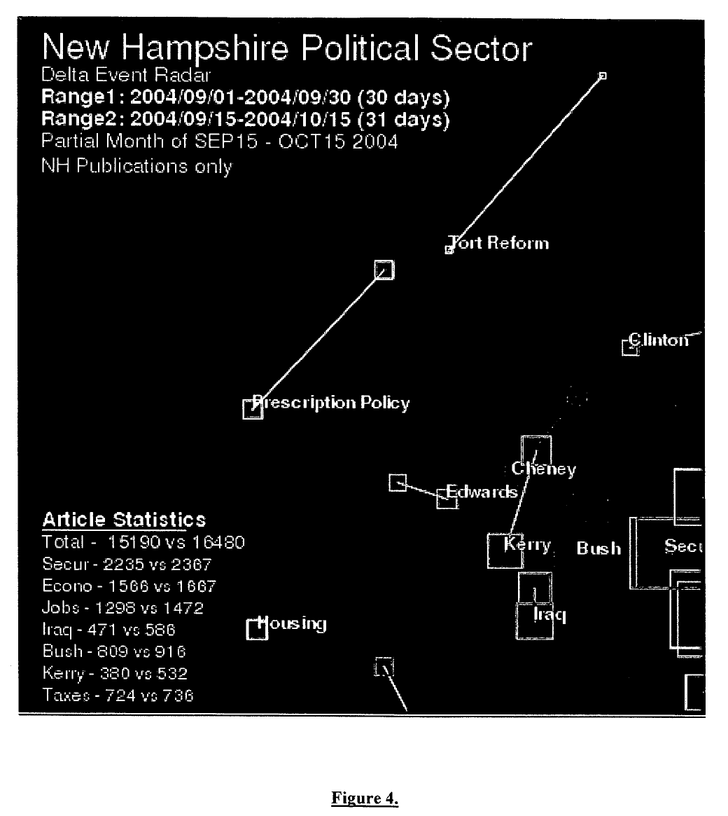

The next step 20 is generating a pictorial representation of the relevancy amongst the news items. FIG. 3 and FIG. 4 are example pictorial representations. In these figures, the square areas represent groups of common news items. The size of the square in FIGS. 3 and 4 is proportional to the number of included news items. The location of the squares is calculated by step 16a. In actual practice, these graphical representations are displayed on a computer screen where a user can use a computer mouse to select groups of news items and the news items that they represent.

Still referring to FIG. 1, after graphical representations are drawn in step 20 of FIG. 1, step 20a is next where the representations are syndicated amongst a community of users through any means of digital communication like World Wide Web browser interfaces or emails. User interaction with pictorial representations produces additional inputs for relevancy as described in step 16. Updates of these relevancy inputs are used in step 22 to update the news database. Once news database is updated with additional relevancy inputs, refined versions of calculations in step 16a can be accomplished with produce refined graphical representation in step 20. The process loops and improves upon itself. For purposes of this description, theses pictorial representations are termed Event Radars.

Event Radars allow machines to display the relationship between the most relevant of thousands of news items meeting a predetermined parameter/ search criteria. Thus, hundreds of relevant news items result. The Event Radar provides a useful context for which to understand the relationship of news items. The Event Radar creates visual patterns out of INN processed news based on the words themselves in the news items the item's SI. Thus, the Event Radar creates patterns out of hundreds to tens of thousands of news items. Referring to FIG. 3, an example of an Event Radar at one given time is shown.

Once these patterns are created, the community machine will show how the patterns move and interact over time. The patterns can also be selected to uncover the news items underlying any particular place in the radar. The end result is the creation of a high level context of the search criteria that is highlighted by relevant news items as part of an integrated INN/Event Radar system. Also, each item is tagged with an ever-changing swarm index number.

Referring still to FIG. 3, Event Radar plots important relationships of news events upon a map surface from which the relationships interact, move, emerge and dissipate over time, and each of these is visually apparent. Hundreds, thousands or tens of thousands of news items can be captured in a single plot. The plot 32, in this example, is done for a community network interested in the wireless sector. In this example, the INN has already scanned news based on predetermined parameters/criteria using search terms relevant to the wireless sector and has integrated the news and calculated the relevancy of the news items. The community reacted to the relevant news items and the real time SI was calculated for time X. The plot 32 represents an Event Radar for time X.

The plot 32 shows the major criteria terms 34, 36 in a spatial relationship. The spatial relationship indicates the relationship of the information. The Article Statistics 38 show the different search terms and the number of news items or articles relevant to each of the listed criteria. Further information regarding the items in each area can be found by selecting the area where it would be located. The Event Radar clusters groups of news items into events 34, 36 (i.e., WiFi, CDMA, GSM, Software, WiMAX, China, 4G, Japan) which are large areas that represent the plot coordinates for items related to that event. However, the square area inside the large area are the actual items/articles.

Referring now to FIG. 4, another example of an Event Radar at given times X is shown. This figure exemplifies an alternate view in the Event Radar. This view shown the underlying criteria/articles and the exact spatial relationship of criteria. This view shows events as they change over time.

To create the Event Radars, unstructured data is used as the input. The output contains patterns and structure. In other words, order is created out of chaos. With massive amounts of computing power, the Event Radars compares each news item in a defined competitive environment with every other news item. For example, it is not atypical to compare 10,000 or more news items in one environment. In such an example, the Event Radar algorithms would conduct 100 million comparisons. Once these comparisons are completed, the Event Radar process then clusters groups of news items into events. These groups are then plotted in fixed X-Y space in a zero-net-sum relationship where groups that are similar are plotted next to each other. Those less similar are plotted away from each other. Only one group can occupy the same space, thereby creating a competition for location amongst the event groups.

In practice Event Radar is a visual map of a community's interests, plotted against, for example, emerging threats and opportunities. Event Radar captures any desired digital content, including thousands of news items, and integrates the “hot button” issues visually, for any timeframe. For example, the community can view the strength of connections between issues and sector players, note how major competitors are clustered, even identify vulnerable positions.

Thus, in practice, the Event Radar plots significant trends amongst the chaos of hundreds or tens of thousands of news/intelligence articles. INN is a powerful enabler of situational awareness and intelligence because it allows a community of machines to freely interact with individual news/analysis items while interacting with other community machines. Additionally, the present invention functions without requiring a behavior changes of the community machines. Rather INN operates based on community machines behaving normally while INN operates continuously to gather news/analysis and synthesize intelligence.

In alternate embodiments, another feature of the present invention is the ability to process scanned news into graphical representations while bypassing the initial calculation of community relevancy. This embodiment is represented in FIG. 1 with the series of steps 12 to 14 to 16a to 20 to 20a. After an interactive graphical representation is created, community user interaction can then create relevancy inputs via step 22a that produced updates in step 22 that provide inputs for step 16. This embodiment is useful in creating relevancy where a limited user community first exists.

In alternate embodiments, another feature of the present invention is the ability to track the performance of the news sources. This feature would inform the server which Web sites, networks, etc., previously designated in the scanning criteria, are not useful to a user community.

Another alternate embodiment is the ability to subscribe to other community networks. Another alternate embodiment is the ability to use pre-programmed predetermined parameters/criteria. Another alternate embodiment is the ability to control which predetermined parameters/criteria are publicly accessible and which predetermined parameters/criteria are only privately accessible. Another alternate embodiment is the ability to include in the predetermined parameters/criteria a frequency rate for automatic scanning.

Other additional features involve routing. One possible additional routing feature is the ability to route copies of scanning results from other users' public scanning rules into the user's network. Another possible feature is to route only links to a user's network, instead of all the information at a Web site, to reduce the load on the routing system. Another routing feature could route scanned information to a public or semi-private network for viewing by multiple members of an organization, club or business. Another organizing or routing feature would enable the user to set accessibility parameters for many separately indexed portions of the user network for private, public, or a customized semi-public access.

Based on the foregoing additional features in scanning and routing, there are additional available features for tracking. In alternate embodiments, a ratings system is used for shared network information to determine the value of the work retrieved. The ratings system could track both individual and cumulative ratings. The ratings system could also be used as part of the routing rules, routing information from other individuals'searches based on their ratings. The user to view its publication reach could track retrieved information subscribed to by other networks. In the opposite direction, retrieved information could be tracked to determine the originating source and the path followed to the user. Information on shared networks could also be summarized for the benefit of others who may have interest in viewing the information.

In the context of all of these ideas, articles, work, or other information retrieved can include links, full articles, pictures, or any other type of electronic/digital file or electronic/digital information. Networks can be viewed by individuals, the general public, or any group by using a community machine and can be operated for peer-to-peer communications or as a centralized service, such as a Web site.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

1. A method for generating pictorial representations of relevant information based on community relevance determination comprising the steps of:
searching information based on a criteria;
reporting resulting information as community items;
tracking response of community to said items;
calculating relevancy of each item in said community; and
generating a graphical representation of relevancy of said each item based on community behavior with said item.

2. The method of claim 1 further comprising updating relevance and graphical representation in real time based on continued community behavior.

3. The method of claim 1 wherein said step of calculating relevancy of each item further comprising assigning a swarm index to each item.

4. The method of claim 1 wherein said step of reporting resulting information further comprising indicating most relevant information based on said community behavior.

5. The method of claim 1 wherein said step of reporting resulting information further comprising indicating most relevant information based on each member of said community interaction with said items.

6. The method of claim 1 wherein said information is in digital form.

7. The method of claim 1 wherein said step of reporting resulting information further comprising making one copy of the resulting information on a community accessed server.

8. The method of claim 1 wherein said step of generating a graphical representation comprising wherein said graphical representation is event radar.

9. The method of claim 1 wherein said step of generating a graphical representation comprising wherein said graphical representation is an interactive display integrated to a news collection and a relevancy creation system.

10. A method of generating pictorial representations of relevant information based on community relevance determination comprising the steps of:
searching digital information based on a criteria;
copying one copy of resulting information to a community server as community items;
tracking response of community machines to said items;
determining relevancy of each item in said community using swarm intelligence;
assigning a swarm index to said each item; and
generating a graphical representation of relevancy of said each item based on community behavior with said item.

11. The method of claim 10 further comprising the step of updating swarm index of said items in response to said response of community machines to said items.

12. The method of claim 10 further comprising the step of updating relevance and graphical representation in real time based on continued community interaction with said items.

13. A method for generating pictorial representations of relevant information based on calculated community relevancy comprising the steps of:
searching information based on a criteria;
generating a graphical representation of relevancy;
reporting resulting information as community items;
tracking response of community to said items; and
determining relevancy of each of said items in said community wherein updates based on community relevancy are reflected by adjustments to said generated graphical representation of relevancy.
